(19) United States
(12) Patent Application Publication
(10) Pub. No.: US 2016/0044028 A1
(43) Pub. Date: Feb. 11, 2016

(54) MESSAGE AUTHENTICATION

(71) Applicant: KT CORPORATION, Gyeonggi-do (KR)

(72) Inventors: Jae-Uk CHA, Gyeonggi-do (KR); Seok-Hong KIM, Seoul (KR); Jung-Suk PARK, Seoul (KR); Jung-Wook LEE, Gyeonggi-do (KR); Sung-Taek JUNG, Gyeonggi-do (KR)

(73) Assignee: KT CORPORATION, Gyeonggi-do (KR)

(21) Appl. No.: 14/823,979

(22) Filed: Aug. 11, 2015

(30) Foreign Application Priority Data
Aug. 11, 2014 (KR) 10-2014-0103797

(51) Int. Cl. H04L 29/06; H04L 12/58

(52) U.S. Cl. CPC H04L 63/0853; H04L 51/12

(57) ABSTRACT

The disclosure is related authenticating a digital message exchanged among communication devices. A device may perform, for authenticating a digital message, transmitting an authentication request message to a messaging server when a message is received, receiving an authentication result from the messaging server, and displaying the authentication result with the received message. A server may perform, for authenticating a message, receiving an authentication request message for requesting authentication of a target message from a device that received the target message, performing an authentication procedure in response to the received authentication request message, and transmitting an authentication result message to the device.

### CROSS REFERENCE TO PRIOR APPLICATIONS

The present application claims priority under 35 U.S.C. §119 to Korean Patent Application No. 10-2014-0103797 (filed on Aug. 11, 2014).

### BACKGROUND

The present disclosure relates communication and, more particularly, to providing services related to a digital message, such as authenticating a digital message, notarizing a digital message, and providing advertisement messages associated with a sender.

A messaging service enables multiple parties to exchange digital messages among them through a communication network. Such a digital messaging service may use standardized communication protocols to allow devices of a transmitting end and a receiving end to exchange the digital messages. Such a digital messaging service has been popular. However, a message is not authenticated when a device receives the message.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, a message from a transmitting end may be authenticated by a third party.

In accordance with another aspect of the present embodiment, a receiving end of a message may be enabled to confirm whether contents and a transmission telephone number have been changed after transmitting the message from a transmitting end.

In accordance with still another aspect of the present embodiment, an advertisement message may be provided to a receiver when a transmitting number of an associated message is authenticated.

In accordance with yet another aspect of the present embodiment, a digital message may be notarized in response to a request from a device receiving the digital message.

In accordance with at least one embodiment, a method may be provided for authenticating a digital message by a device. The method may include transmitting an authentication request message to a messaging server when a message is received, receiving an authentication result from the messaging server, and displaying the authentication result with the received message.

The transmitting may include extracting information on a transmitting number, a receiving number, a time stamp, and contents from the received message and transmitting the extracted information with the authentication request message.

The transmitting may include generating the authentication request message to include information on a transmitting number, a receiving number, a time stamp, and contents of the received message and transmitting the generated authentication request message automatically when the message is received.

The transmitting may include inquiring a user of the device whether to request message authentication. When the user requests the message authentication, the transmitting may include extracting information on a transmitting number, a receiving number, a time stamp, and contents from the received message, generating the authentication request message to include the extracted information, and transmitting the generated authentication request message.

The transmitting may include transmitting device information of the device to the messaging server.

The transmitting may include transmitting connection state information of the device to the messaging server.

The receiving may include receiving advertisement information associated with a transmitting number of the received message from the messaging server.

The receiving may include receiving a long advertisement message associated with a transmitter number of the received message from the messaging server when the device is connected to a data network for receiving data at a comparatively high transmit rate, otherwise, receiving a short advertisement message associated with the transmitter number of the received message from the messaging server.

The displaying may include displaying advertisement information associated with a transmitting number of the received message with the authentication result.

The method may include inquiring a user of the device whether to request a digital notary service. When the user requests the digital notary service, the method may further include extracting information on a transmitting number, a receiving number, a time stamp, and contents from the received message, generating a notary request message to include the extracted information, and transmitting the generated notary request message.

In accordance with another embodiment, a method may be performed for authenticating a message by a server. The method may include receiving an authentication request message for requesting authentication of a target message from a device that received the target message, performing an authentication procedure in response to the received authentication request message, and transmitting an authentication result message to the device.

The receiving may include extracting information on the target message from the received authentication request message. The extracted information may include information on a transmitting number, a receiving number, a time stamp, and contents of the target message.

The performing may include comparing target message information extracted from the received authentication request message with associated authentication information stored in a database of the server and determining whether the target message information is about identical to the associated authentication information.

The performing may include determining that the target message is authenticated when target message information is about identical to associated authentication information stored in the server when the target message is transmitted from the other device.

The performing may include determining whether a transmitting number of the target message is included in a spam list stored in a database of the server.

The method may further include obtaining an advertisement message associated with a transmitting number of the target message from an associated database and transmitting the obtained advertisement message with the authentication result message to the device.

The method may further include receiving connection state information of the device from the device and determining whether the device is connected to a data network for receiving data at a comparatively high transmit rate based on the connection state information.

The transmitting may include transmitting a comparatively short advertisement message with the authentication result message when the device is not connected to the data network and transmitting a comparatively long advertisement message with the authentication result message when the device is connected to the data network.

The method may further include receiving a notary service request message from the device, extracting notary information and target message information from the notary service request message and requesting a notary service server to notarize a target message based on the extracted notary information and target message information, and receiving a notary result message and transmitting the received notary result message to the device.

The method may further include receiving a message to be transmitted to a designated device, extracting information on at least one of a transmitting number, a receiving number, a time stamp, and contents from the message, and storing the extracted information as authentication information of the received message.

### BRIEF DESCRIPTION OF THE DRAWINGS

The above and/or other aspects of some embodiments of the present invention will become apparent and more readily appreciated from the following description of embodiments, taken in conjunction with the accompanying drawings, of which:

FIG. 1 illustrates a network environment for providing a digital message authentication service in accordance with at least one embodiment;

FIG. 2 illustrates operation of a receiving device for a digital message authentication service in accordance with at least one embodiment;

FIG. 3 illustrates a service server for providing a digital message authentication service in accordance with at least one embodiment;

FIG. 4 illustrates operation of a service server for providing a digital message authentication service in accordance with at least one embodiment; and

FIG. 5 illustrates a graphic user interface of a receiving device for inquiring a recipient to initiate at least one of or none of a message authentication procedure and a message notary procedure;

FIG. 6 illustrates a graphic user interface displayed on a receiving device for informing of a recipient that at least one of or none of a message authentication procedure and a message notary procedure is activated and a current state of the message authentication procedure in accordance with at least one embodiment;

FIG. 7 illustrates a graphic user interface displayed on a receiving device for displaying a message authentication result and advertisement information in accordance with at least one embodiment;

FIG. 8 exemplary illustrates a graphic user interface of a receiving device, showing results of a message authentication procedure performed automatically in accordance with at least one embodiment;

FIG. 9 exemplary illustrates a graphic user interface for displaying a spam warning message when the received message is associated with a spam number in accordance with at least one embodiment; and

FIG. 10 illustrates a graphic user interface for displaying a warning message when the received message includes a suspicious file in accordance with at least one embodiment.

### DETAILED DESCRIPTION OF EMBODIMENTS

Reference will now be made in detail to exemplary embodiments of the present invention, examples of which are illustrated in the accompanying drawings, wherein like reference numerals refer to like elements throughout. The embodiments are described below, in order to explain embodiments of the present invention by referring to the figures.

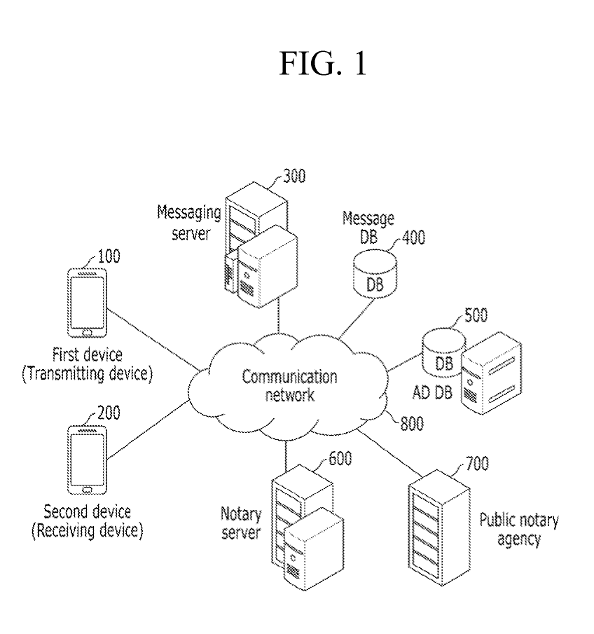

In accordance with at least one embodiment, a message authentication service may be provided to a message recipient. Such a message authentication service may be provided with a message notary service and advertisement information associated a sender of a message. In particular, a receiving device may request a service server for providing a message authentication service when the receiving device receives a digital message, receive an authentication result with advertisement information associated with a sender from the service server, and display the authentication result and the advertisement information through a predetermined output unit. In addition, the receiving device may request a digital notary service for the received message in accordance with at least one embodiment. Hereinafter, an overall communication environment for authenticating a digital message in accordance with at least one embodiment will be described with reference to FIG. 1.

FIG. 1 illustrates a network environment for providing a digital message authenticating service in accordance with at least one embodiment.

Referring to FIG. 1, such a network environment for the digital message authenticating service may include first device 100 (e.g., transmitting device), second device 200 (e.g., receiving device), messaging server 300, message database (DB) 400, advertisement database (AD DB) 500, notary server 600 (e.g., or digital notary service server 600), public notary agency 700, and communication network 800. First device 100 communicates with second device 200 through communication network 800. In particular, one of first device 100 and second device 200 transmit messages to and receive message from the other through messaging server 300 in accordance with at least one embodiment.

For convenience and ease of understand, messaging server 300, message database 400, advertisement database 500, notary server 600, and public notary agency 700 illustrated as separated and independent computing systems or servers for providing a digital authentication service including a digital notary service. However, the present embodiment is not limited thereto. For example, messaging server 300, message database 400, and advertisement database 500 may be implemented as one server in accordance with another embodiment. Digital notary service server 600 and public notary agency 700 may be implemented as one server in accordance with another embodiment. Alternatively, messaging server 300, message database 400, advertisement database 500, digital notary service server 600, and public notary agency 700 may be implemented as one server.

As shown in FIG. 1, first device 100, second device 200, messaging server 300, message database 400, advertisement database 500, digital notary service server 600, and public notary agency 700 are connected each other through communication network 800. Such communication network 800 may enable first device 100, second device 200, messaging server 300, message database 400, advertisement database 500, digital notary service server 600, and public notary agency 700 to communicate to each other using predetermined communication technologies and protocols. For example, communication network 800 may employ technologies and protocols associated with, but not limited to, Wi-Fi, Bluetooth, a local area network (LAN), a wireless LAN, a wide area network (WAN), a personal area network (PAN), a 3G communication technology, a 4G communication technology, and a long term evolution (LTE) technology.

First device 100 and second device 200 may be an electronic device capable of processing predetermined operations, storing data, and communicating with a designated device through a preferred communication network. First device 100 and second device 200 may have portability and mobility. For example, first device 100 and second device 200 may include a personal communication system (PCS), a global system for mobile communications (GSM) device, a personal digital cellular (PDC) device, a personal handy phone system (PHS), a personal digital assistant (PDA), an international mobile telecommunication (IMT)-2000 device, a code division multiple access (CDMA)-2000 device, a wide code division multiple access (W-CDMA) device, a wireless broadband internet (WiBro) device, a smart phone, a tablet, a laptop computer, a stick computer, and so forth.

For convenience and ease of understanding, first device 100 may be referred to as transmitting device 100 and second device 200 may be referred to as receiving device 200, but the present embodiment is not limited thereto. In accordance with at least one embodiment, transmitting device 100 transmits a digital message to a receiving device 200 through messaging server 300 using communication network 800 of a preferred communication service provider. Such transmitting device 100 may denote any electronic device (e.g., a device, a terminal, or user equipment) that transmits a digital message to a recipient in response to a user input from one (e.g., a sender) who wants to send a digital message to the other. Transmitting device 100 may be also referred to as a transmitter, a transmitting end, a caller, a sender, a transmitting terminal, and so forth. Receiving device 200 may denote any electronic device (e.g., a device, a terminal, or user equipment) that receives a digital message from a sender (e.g., transmitting device 100). Such receiving device 200 may be also referred to as a receiver, a receiving end, a recipient, a receiving side, a receiving terminal, and so forth.

The digital message may denote a message generated in a predetermined digital format and be transmitted or received through a communication network (e.g., 800) using predetermined protocols and communication technologies. For example, the digital message may be exchanged through a short message service (SMS) or a multimedia messaging service (MMS), but the present embodiment is not limited thereto. The digital message may include a text message, a short message, a multimedia message, and so forth. That is, the digital message may include not only texts, voices, pictures, and digital audio/video files.

In accordance with at least one embodiment, first and second devices 100 and 200 may receive a digital message through messaging server 300. First and second devices 100 and 200 may have at least one hardware component configured to and/or at least one of applications programmed to perform operations for authenticating a text message authentication (e.g., text message authentication service). Such a hardware component may be mounted at first and second devices 100 and 200 as a constituent element by a manufacturer of devices 100 and 200. Alternatively, the hardware component may be manufactured and distributed by at least one of a manufacturer of devices 100 and 200, a communication service provider, a message service provider, and a third party. Such a hardware component may be connected to devices 100 and 200 through a wired link or a wireless link and communicate with devices 100 and 200 using a predetermined protocol through one of interfaces equipped at devices 100 and 200. Furthermore, the applications may be produced and distributed by at least one of a manufacturer of devices 100 and 200, a communication service provider, a message service provider, and a third party. Such application may be preinstalled at devices 100 and 200 with an operating system of devices 100 and 200 or may be downloaded from a server of an associated service provider and installed in devices 100 and 200.

For example, first and second devices 100 and 200 may be registered at messaging server 300 for a digital message authentication service, a digital message notary service, and an advertisement service. Upon the registration, first and second devices 100 and 200 may download associated applications for the digital message authentication service, the digital notary service, and the advertisement service from messaging server 300 and be installed with the downloaded applications. Such a downloaded application may be executed upon generation of a predetermined event, running with other applications and an operating system of a device, and produce and display designated user interface with existing user interfaces upon receipt of a digital message in order to enable first and second devices 100 and 200 to initiate and perform a digital message authentication procedure in connection with messaging server 300 in accordance with at least one embodiment.

In accordance with at least one embodiment, receiving device 200 may perform operation for initiating a message authentication procedure upon the receipt of a message. In particular, receiving device 200 may transmit a message authentication request message automatically or manually to messaging server 300. The message authentication message may include information necessary for authenticating the message, for example, at least one of a transmitting number (e.g., a telephone number of a sender), a receiving number (e.g., a telephone number of a receiver), a time stamp (e.g., transmission time or reception time), and contents of the message. Furthermore, the message authentication request message may include a hash value of at least one of the transmitting number, the receiving number, the time stamp, the contents, and combination thereof.

Receiving device 200 may transmit device information and connection state information to messaging server 300 together with the message authentication request message or through separated messages. For example, when transmitting the message authentication request message, receiving device 200 may further transmit device information, such as, a serial number, a model number, international mobile equipment identity (IMEI), a universal subscriber identity module (USIM) number, international mobile subscriber identity (IMSI), and an allocated authentication key. Furthermore, receiving device 200 may transmit connection state information of receiving device 200. The connection state information is information on a connection state of receiving device 200. The connection state information of receiving device 200 indicates whether receiving device 200 is connected to a data network (e.g., packet switched network or Internet network) supporting a comparatively high transmit rate for receiving a large amount of data.

Receiving device 200 may transmit a digital rotary service request message with the message authentication request message. For example, when receiving device 200 requests the message authentication service, receiving device 200 may request a message notary service in response to a user input from a user of receiving device 200.

In response to the message authentication request message, receiving device 200 may receive a message authentication result message from messaging server 300 and an advertisement message associated with a transmitting number of the message. The transmitting number may be a telephone number of a message sender, which might be registered at messaging server 300 for related services. Furthermore, receiving device 200 may receive a spam warning message that indicates whether the received message is a spam message or the transmitter number (e.g., telephone number) of a sender is in a spam number list.

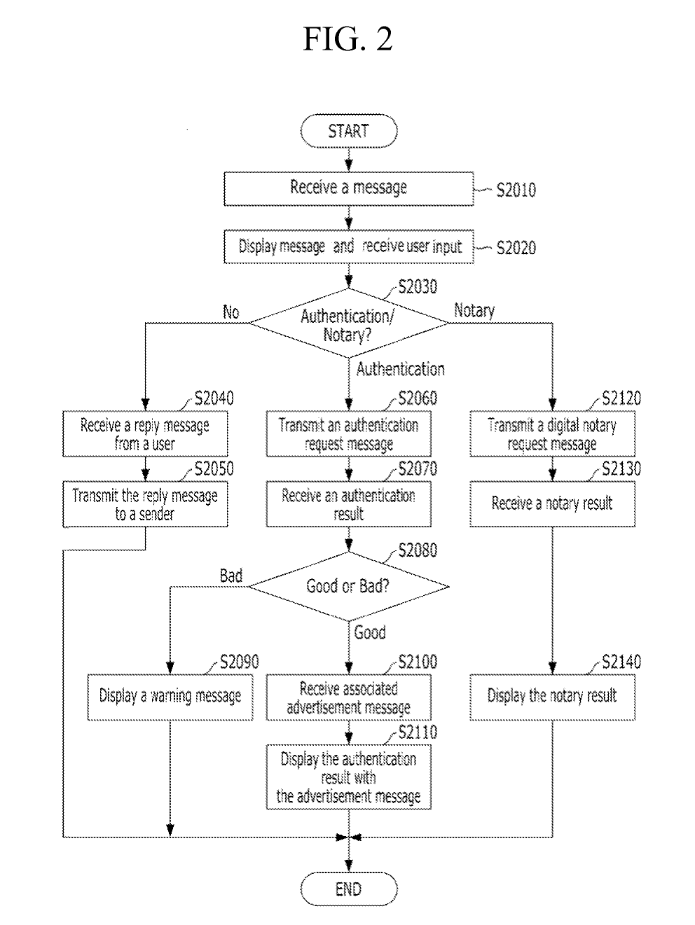

Receiving device 200 may display, on a screen of receiving device 200, the message authentication result message, the advertisement message, and the spam warning message within a predetermined user interface displayed with a typical messaging window. Furthermore, receiving device 200 may output the message authentication result message, the advertisement message, and the spam warning message through other output units, such as a speaker and a vibrating unit of receiving device 200. Such operations of receiving device 200 will be described in more detail with reference to FIG. 2.

Messaging server 300 may i) be a computing system including at least one processor, at least one memory, and at least one communication circuit, ii) owned and managed by a service provider of a message authentication service and/or a messaging service, and iii) perform operations related to the message authentication procedure and the digital notary procedure in accordance with at least one embodiment. For example, messaging server 300 may receive a message authentication request message from receiving device 200, perform a message authentication procedure based on information included in the message authentication request message, and transmit a message authentication result message to receiving device 200. As described, the message authentication request message may include information on a transmitting number, a receiving number, a time stamp, and message contents.

Messaging server 300 may also perform operations for obtaining advertisement information associated with a sender of the message based on the transmitting number in the message authentication request message in cooperation with advertisement contents database 600. Furthermore, messaging server 300 may generate an advertisement message to include the obtained advertisement information and transmit the generated advertisement message with the message authentication result message to receiving device 200.

Messaging server 300 may receive device information of receiving device 200. Based on the received device information, messaging server 300 may request messaging server to authenticate receiving device 200. Such authentication procedure may prevent an unauthorized person (e.g., hacker) from illegally notarizing an associated message although such an unauthorized person illegally obtains authentication information of receiving device 200.

Messaging server 300 may receive connection state information of receiving device 200. Based on the connection state information of receiving device 200, messaging server 300 may determine whether receiving device 200 is capable of receiving a large amount of advertisement data at a comparatively high transmit rate without incurring extra cost. For example, when the received connection state information indicates that receiving device 200 is connected to a data communication network, messaging server 300 may select advertisement options and information having comparatively large amount of data and transmit the selected advertisement information (e.g., long advertisement message or large advertisement message) to receiving device 200. When the received connection state information indicates that receiving device 200 is not connected to a data communication network, messaging server 300 may select advertisement options and information having comparatively small amount of data and transmit the selected advertisement information (e.g., short advertisement message or small advertisement message) to receiving device 200.

Based on a transmitting number of a target message to be authenticated, messaging server 300 determines whether the transmitting number is a spam number based on a spam number list stored in a database. The transmitting number may be a telephone number or an IP address of a sender. Such a spam number list is stored, updated, and managed by messaging server 300 upon generation of a predetermined event, for example, when a spam number is detected, when a suspicious message is detected, when a message is determined as having modified contents after transmitted from an origin. As a result of determination, messaging server 300 may generate and transmit a spam number warning message.

As described, messaging server 300 may receive a digital notary request message from receiving device 200. In this case, messaging server 300 may request a digital notary service to digital notary service server 600 by transmitting information on a target message and receiving device 200, such as a transmitting number of transmitting device 100 (e.g., a sender), a receiving number of receiving device 200, a transmission time of a target message, contents of the target message, information on whether the target message is read by a receiver, a predetermined hash value, and so forth.

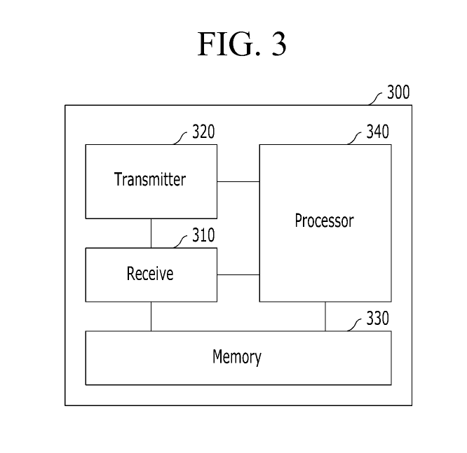

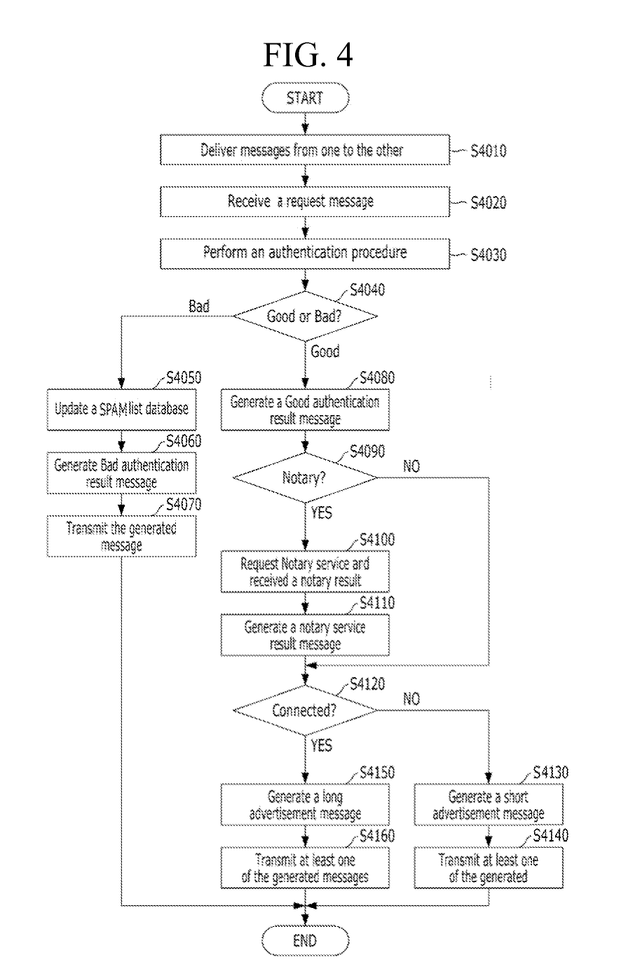

As described, messaging server 300 may be a computing system for a messaging service provider that provides a messaging service to registered subscribers. For example, a subscriber (e.g., communication devices) may register at messaging server 300 for transmitting and receiving messages, and messaging server 300 may manage the registered subscribers and deliver various types of messages from one subscriber to the other. However, the present embodiment is not limited thereto. Messaging server 300 may be an independent computing system for performing the message authentication operation, separated from a service server for managing and delivering messages from one subscriber to the other. Such operations of messaging server 300 for the message authentication procedure will be described in more detail with reference to FIG. 3 and FIG. 4.

Message database (DB) 400 may be a computing system including at least one processor, a communication circuit, and memories, for managing a large number of memory storages for storing messages exchanged among registered subscribers and contents and supplementary information of the messages. For example, message database 400 may store information on messages exchanged among registered subscribers, such as a transmitting number, a receiving number, a time stamp, and contents of respective message. In response to requests, message database 400 may provide information on a requested message to messaging server 300, notary service server 600, public notary organization 700, and subscriber (e.g., devices 100 and 200).

Although message database 400 is illustrated as an independent system from messaging server 300, the present embodiment is not limited thereto. For example, message database 400 may be implemented with messaging server 300 as one computing system. Furthermore, message database 400 may be a group of computers with storage devices coupled together through a predetermined communication network (e.g., cloud storage system).

Advertisement database (AD DB) 500 may be a computing system including at least one processor, a communication circuit, and memories, for managing a large number of memory storage that store advertisement contents of respective registered senders. For example, when subscriber registers at messaging server 300 and/or advertisement database 500, such registered subscriber may be allowed to store own advertisement contents. Advertisement database 500 may store two types of advertisement contents for each registered subscriber, for example, a small advertisement message (e.g., short advertisement message) containing a comparatively small amount of advertisement data and a large advertisement message (e.g., long advertisement message) containing a comparatively large amount of advertisement data. For example, the small advertisement message may be a simple text message and the large advertisement message may include an image, a moving image, uniform resource locator (URL) information, and so forth. One of the small advertisement message and the large advertisement message may be selected according to connection state information of a receiving device. In response to a request, advertisement database 500 may provide advertisement information associated to a sender (e.g., transmitting device) to messaging server 300.

Although advertisement database 500 is illustrated as an independent system from messaging server 300, the present embodiment is not limited thereto. For example, advertisement database 500 may be implemented with messaging server 300 as one computing system. Furthermore, advertisement database 500 may be a group of computers with a plurality of storage devices coupled together through a predetermined communication network (e.g., cloud storage system).

In addition to advertisement database 500 and message database 400, a spam information database (not shown) may be coupled to messaging server 300 through communication network 800. Such a spam information database may store a list of spam numbers and spam messages for identifying suspicious messages and senders. Such a spam information database may be updated and managed by messaging server 300 upon generation of a predetermined event.

Digital notary service server 600 may be a computing system including at least one processor, a communication circuit, and memories, for notarizing a target message in response to a request from messaging server 300 in cooperation with public notary agency 700. For example, notary service server 600 may receive a notary service request message from messaging server 300 with information on a target message to be notarized, request the notary service to public notary agency 700 by delivering the information on the target message to public notary agency 700, and receive a notarizing result (e.g., notary certificate) from public notary agency 700. Although digital notary service server 600 is illustrated as an independent system from messaging server 300, the present embodiment is not limited thereto. For example, digital notary service server 600 may be implemented with messaging server 300 as one computing system.

Public notary agency 700 may be i) a computing system including at least one processor, a communication circuit, and memories, ii) owned and managed of a public organization for notarizing digital messages for public, and iii) perform operations notarizing a target message. For example, public notary agency 700 may i) receive a notary request message from messaging server 300 or digital notary service server 600 with information on a target message, store information on the received target message for a predetermined time period; ii) inquire at least one information on the target message to a message sender (e.g., transmitting device 100), to a message recipient (e.g., receiving device 200), to messaging server 300, in order to determine whether a message sender transmits a target message, determine whether a message recipient receives a target message, determine whether contents of a target message is not modified, and so forth; iii) transmit the inquiry result of a target message as the notary result (e.g., public notary certificate) to at least of notary service server 600, messaging server 300, receiving device 200, and transmitting device 100.

As described, receiving device 200 may perform a message authentication procedure upon the receipt of a message from transmitting device 100. Hereinafter, such operation of receiving device 200 for a digital message authentication service will be described in detail with reference to FIG. 2 and FIG. 5 to FIG. 10.

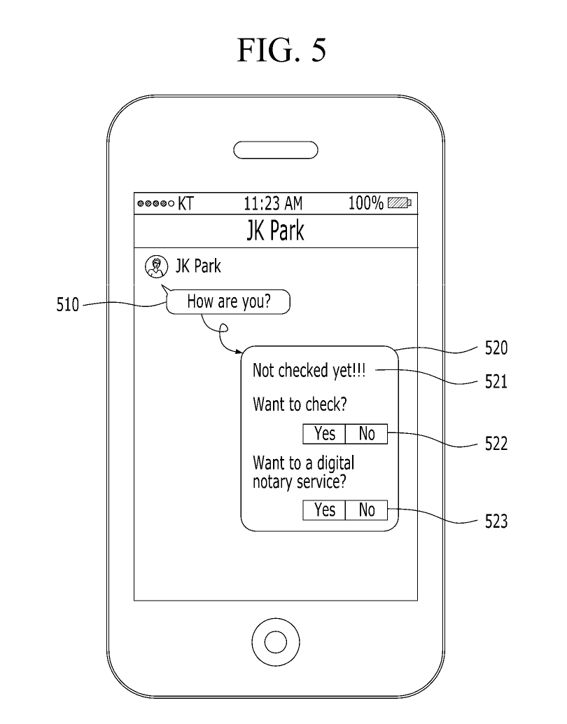

FIG. 2 illustrates a method of authenticating a digital message by a receiving device in accordance with at least one embodiment. FIG. 5 to FIG. 10 exemplary illustrate graphic user interfaces for perform a message authentication procedure in accordance with at least one embodiment.

Referring to FIG. 2, at step S2010, a message may be received at a receiving device through a messaging server. For example, transmitting device 100 transmits a digital message to receiving device 200 through messaging server 300 using communication network 800 of a preferred communication service provider. Then, receiving device 200 receives the message from transmitting device 100. Such a message may denote a digital message, and the message may include a text message, a multimedia message, and so forth.

At step S2020, the received message with an authentication request window may be displayed and a user input may be received. For example, receiving device 200 may have at least one hardware component configured and at least one application programmed to perform operations for digital message authentication. Such a hardware component or application may produce a graphic user interface 520 when receiving device 200 receives message 510, as shown in FIG. 5. FIG. 5 illustrates a graphic user interface for inquiring a receiver to initiate at least one of or none of a message authentication procedure and a message notary procedure. For example, authentication request window 520 may include information on current authentication state 520 of the received message 510. Since received message 510 is not authenticated yet, current authentication state 520 is marked as “Not checked yet”. In addition, authentication request window 520 may include icons 522 for initiating a message authentication procedure and icons 523 for initiating a notary service procedure.

Through authentication request window 520, a recipient may select one of icons 522 and 523 for initiating a message authentication procedure and a message notary procedure. In FIG. 5, the message authentication procedure is illustrated as being initiated manually by a user input, but the present embodiment is not limited thereto. The message authentication procedure may be performed automatically upon generation of a predetermined event (e.g., when a message is received).

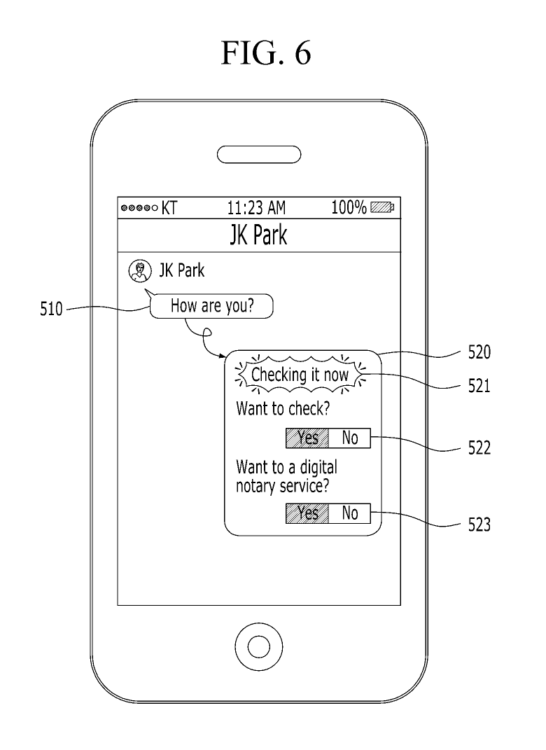

At step S2030, determination may be made so as whether the received input is for initiating at least one of or none of a message authentication procedure and a message notary procedure. For example, receiving device 200 determines whether one or none of icons 522 and icons 523 is activated for initiating the message authentication procedure, and/or the message notary procedure. As shown in FIG. 6, when a recipient selects “Yes” icons, corresponding icons may be displayed with special effects, such as blanking or highlighted.

When none of the message authentication procedure and a message notary procedure is selected (No—S2030), the received message may be displayed in a normal message window at step S2040, and a reply message may be received and transmitted at step S2050. For example, receiving device 200 closes authentication request window 520 and displays received message 510 normally. When receiving device 200 receives user inputs as a reply message, receiving device 200 transmits the received reply message to transmitting device 100 through messaging server 300.

When the message authentication procedure is selected (Authentication—S2030), an authentication request message may be generated and transmitted at step S2060. For example, when receiving device 200 receives a user input activating the message authentication procedure through clicking “yes” icon 522, receiving device 200 initiates a message authentication procedure. In particular, receiving device 200 may generate an authentication request message. For example, FIG. 6 illustrates a graphic user interface for informing at least one of or none of a message authentication procedure and a message notary procedure is activated and a current state of the message authentication procedure in accordance with at least one embodiment. As shown in FIG. 6, “yes” icon 522 is blanked, and current state information 520 is displayed as “checking.”

The authentication request message may be generated to include information necessary for authenticating a digital message. For example, the authentication request message may include information on, at least one of, identification of transmitting device 100 (e.g., transmitting number), identification of receiving device 200 (e.g., receiving number), a time stamp of the message, and contents of the message. The identification of transmitting device 100 may be any information that can be used for identifying transmitting device 100 and an associated sender (e.g., caller). The identification of receiving device 200 may be any information that can be used for identifying receiving device 200 and an associated receiver (e.g., callee). For example, the identification information of devices 100 and 200 may include international mobile equipment identity (IMEI), a universal subscriber identity module (USIM) number, international mobile subscriber identity (IMSI), a telephone number, and an Internet Protocol (IP) address.

In particular, the authentication request message may be generated to include at least one of a telephone number of transmitting device 100, a telephone number of receiving device 200, a time stamp of a message, and contents of a message. Furthermore, the authentication request message may include a hash value obtained by combining at least one of the telephone numbers of devices 100 and 200, the time stamp, and the contents and calculating the hash value of the combination result.

The identification of transmitting device 100 and receiving device 200 may be used to authenticate an origin and a destination of the message. The contents of the message may be used to determine whether the contents of the message have been modified after the message was transmitted from transmitting device 100. The time stamp may be used to identify messages having the same sender and recipient (e.g., caller and callee).

Receiving device 200 may further transmit information on receiving device 200, such as a serial number, a model name, an IMEI, a USIM number, an IMSI, and/or an allocated authentication key. However, the present embodiment is not limited thereto.

Furthermore, receiving device 200 may transmit connection state information that indicates whether receiving device 200 is connected to a data communication network. Such connection state information may be used to determine whether receiving device 200 is capable of receiving a large amount of data or to select types of advertisements to be provided to receiving device 200.

Although receiving device 200 is described as inquiring a receiver (e.g., a user of receiving device 200, a callee) whether to request the message authentication service on the received message before transmitting the authentication request message, such an inquiry operation may be omitted by preference of a corresponding user. That is, the transmission of the authentication request message may be performed automatically or manually according to a user setting for the message authentication service. In manual, the transmission of the authentication request message may be performed according to a result of the authentication inquiry operation in accordance with at least one embodiment. Such automatic transmission or manual transmission of the authentication request message may be configured based on settings controlled by a corresponding user.

At step S2070, a message authentication result may be received. For example, receiving device 200 receives an authentication result from messaging server 300. Messaging server 300 may authenticate the target message by comparing the information included in the received request message with authentication information stored in message database 400. The authentication information of the target message is information of the target message, which was extracted from the target message by messaging server 300 and stored in message database 400 by messaging server 300 when messaging server 300 delivered the target message from transmitting device 100 to receiving device 200. Messaging server 300 may transmit an authentication result message to receiving device 200.

At step S2080, receiving device 200 may determine whether the received message authentication result is an authentication fail message or an authentication success message. When the received message authentication result is the authentication fail message (F—S2080), receiving device 200 may display a warning message at step S2090. For example, receiving device 200 displays messages for informing of the recipient that the received message is modified, the received message contains suspicious files (e.g., virus files), and/or the transmitter of the received message is in the spam list.

When the received message authentication result is the authentication success message (S—S2080), receiving device 200 may receive advertisement information at step S2100. For example, receiving device 200 may receive advertisement information associated with a transmitting number of the text message.

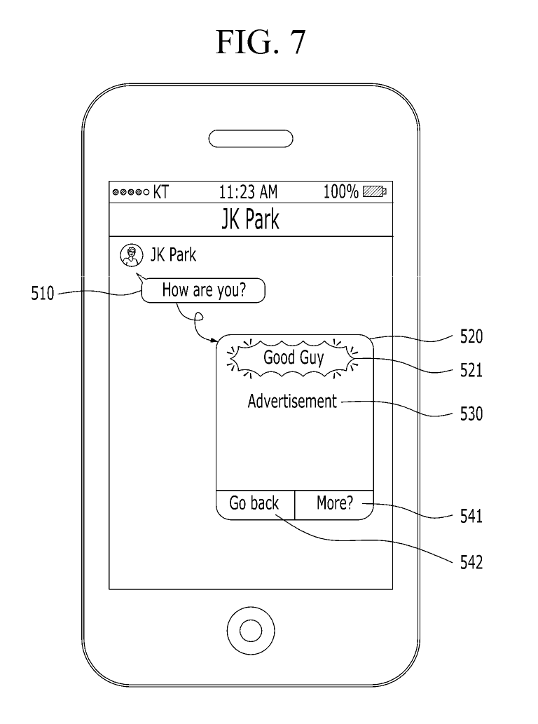

At step S2110, the authentication result and the advertisement content may be displayed. For example, receiving device 200 displays the received authentication result and the advertisement information within a predetermined area of a display unit, which may be produced and displayed by a predetermined application related to the message authentication service. For example, FIG. 7 illustrates a graphic user interface displayed on receiving device 200 for displaying a message authentication result and advertisement information in accordance with at least one embodiment. As shown in FIG. 7, current state information 521 is displayed as “Good Guy” for indicating that the received authentication result is the authentication success message. Furthermore, advertisement information 530 associated with a transmitter (e.g., transmitting device 100) is displayed.

In addition, optional icons 541 and 542 may be provided as shown in FIG. 7. For example, “more?” icon 541 may enable the recipient to have more detailed advertisement information of the transmitter. That is, receiving device 200 may display further detailed (e.g., supplementary) advertisement information in response to a user input in accordance with at least one embodiment. That is, when a user wants to learn more about the displayed advertisement, the user may make a predetermined user input to see the further detailed advertisement information. For example, when receiving device 200 receives a user input for selecting “more?” icon 541, receiving device 200 may open an associated web-site or connect an answering response system (ARS). For the ARS, various methods may be used to connect receiving device 200 to the ARS, such as from receiving device 200,

For the ARS, receiving device 200 may retransmit a transmitting number, a receiving number, a time stamp, and contents of a message to messaging server 300. Messaging server 300 may use the information from receiving device 200 to connect receiving device 200 to the ARS. That is, messaging server 300 may determine which message is associated with the request of receiving device 200 for ARS connection.

Referring back to FIG. 2, when the message notary procedure is selected (Notary—S2030), a digital notary request message may be generated and transmitted at step S2120. For example, in addition to the message authentication procedure, a message notary procedure may be performed in response to a user input. In particular, a message notary service may be requested after or at the same time of requesting a message authentication service, as shown in FIG. 5. The message notary service may be referred to as a digital notary service for notarizing messages electrically. In particular, a particular message may be notarized for officially approving, by a third party, i) a transmitter, ii) a receiver, iii) contents, iv) a transmission time, and v) a reception time of the particular message. As a result of the notarizing, a public notary certificate may be issued and transmitted to receiving device 200 through messaging server 300.

In particular, when receiving device 200 receives a user input to activate “yes” icon 523 of FIG. 5, receiving device 200 generates the notary service request message to include information necessary for notarizing a target message (e.g., received message 510 of FIG. 5). Such information may include information on i) a transmitter, ii) a receiver, iii) contents, iv) a transmission time, and v) a reception time, but the present embodiment is not limited thereto. Receiving device 200 may transmit the generated request message to at least one of messaging server 300 and notary service server 600. For example, in response to the request message, messaging server 300 may initiate a message notary procedure in cooperation with notary service server 600. Notary service server 600 requests public notary agency 700 to notarize a target message, receives a notary result from public notary agency 700, and transmits the notary result to at least one of messaging server 300, receiving device 200, and transmitting device 100. Furthermore, notary service server 600 and/or public notary agency 700 may store the notary information associated with the target message, including the issued public notary certificate, for a predetermined time period. Such stored notary information may be provided to an authorized device in response to a request.

At step S2130, a notary result may be received. At step S2140, the notary result may be displayed. For example, receiving device 200 receives the notary result (e.g., public notary certificate) from messaging server 300 and displays on a screen thereof.

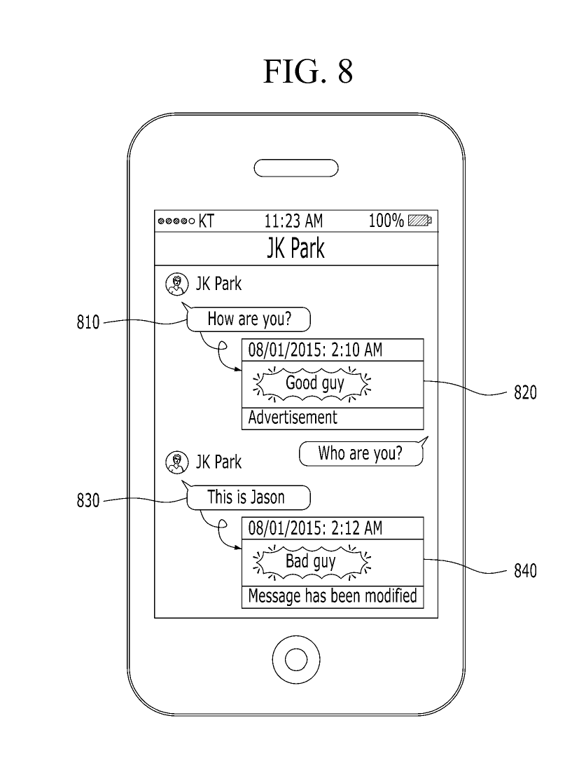

As described, the message authentication procedure may be performed automatically. FIG. 8 exemplary illustrates a graphic user interface of a receiving device, showing results of a message authentication procedure performed automatically in accordance with at least one embodiment. As shown in FIG. 8, the message authentication procedures may be automatically performed for received messages 810 and 830. Furthermore, authentication results 820 and 840 of corresponding messages 810 and 830 are displayed.

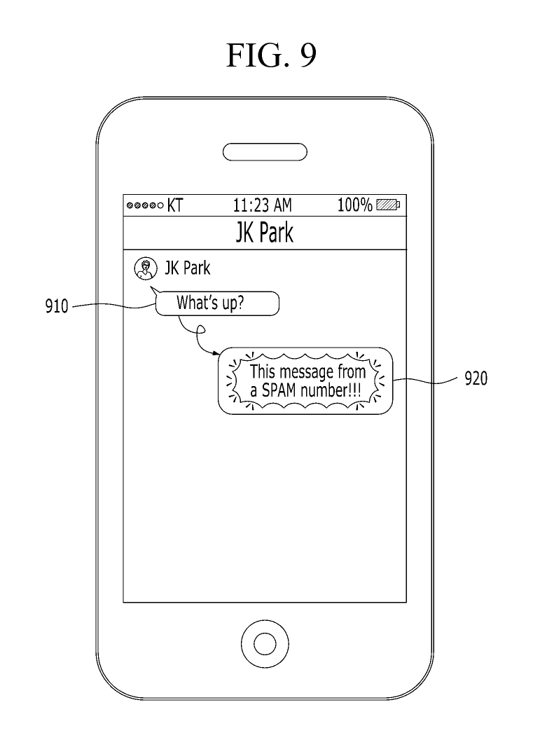

In addition to the authentication results, receiving device 200 may receive information on whether a transmitting device of the received message is associated with a spam number. When it is a spam number, receiving device 200 may display a warning message on a display unit. FIG. 9 exemplary illustrates a graphic user interface for displaying a spam warning message when the received message is associated with a spam number.

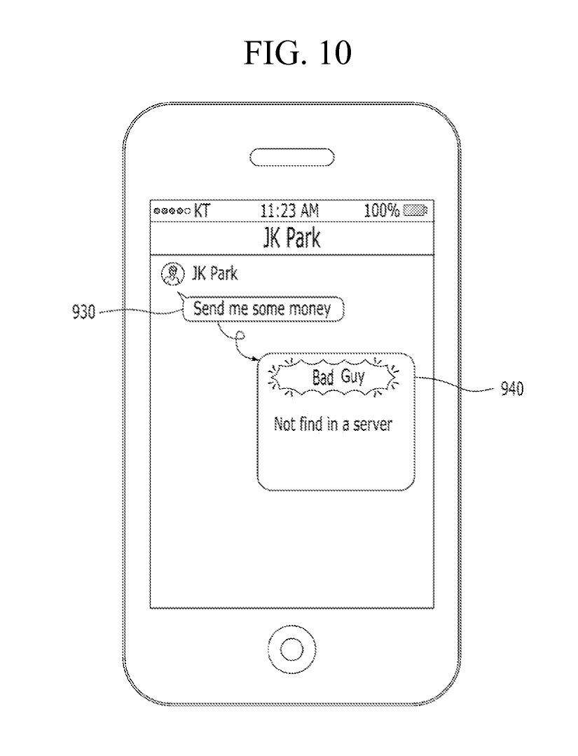

Furthermore, receiving device 200 may receive information that the target message includes virus or information that a suspicious file is attached at the received message. In this case, receiving device 200 displays such information as shown in FIG. 10. FIG. 10 illustrates a graphic user interface for displaying a warning message when the received message includes a suspicious file in accordance with at least one embodiment.

As described, messaging server 300 may perform a message authentication procedure and a message notary procedure in response to a request message from receiving device 200 in accordance with at least one embodiment. Hereinafter, such messaging server 300 will be described with reference to FIG. 3 and FIG. 4.

FIG. 3 illustrates a messaging server in accordance with at least one embodiment.

Referring to FIG. 3, messaging server 300 may be a computing system owned and managed by a service provider that provides a message authentication service and/or a messaging service to registered users (e.g., subscriber). For example, messaging server 300 may perform operations related to the message authentication procedure and the digital notary procedure in accordance with at least one embodiment. Such messaging server 300 may include a communication circuit including transmitter 310, receiver 320, memory 330, and processor 340.

The communication circuit including transmitter 310 and receiver 320 may establish a communication link to at least one of first and second devices 100 and 200, message database 400, advertisement database 500, notary service server 600, and public notary agency 700 through communication network 800. Through the established link, the communication circuit may receive information from or transmit information to at least one of first and second devices 100 and 200, message database 400, advertisement database 500, notary service server 600, and public notary agency 700. For example, the communication circuit may perform communication based on Digital Subscriber Line (xDSL), Hybrid Fiber Coaxial (HFC), Power Line Communication (PLC), satellites, GSM EDGE Radio Access Network (GERAN), UMTS Terrestrial Radio Access Network (UTRAN), evolved UMTS Terrestrial Radio Access Network (eUTRAN), Wireless Local Area Network (WLAN), and Worldwide Interoperability for Microwave Access (WiMAX), or a mobile communication network based on CDMA/WCDMA or GSM/GPRS.

For example, through such an established link, receiver 320 may receive a message authentication request message from receiving device 200. Such a message authentication request message may include information on a transmitting number, a receiving number, a time stamp, and message contents. Furthermore, receiver 320 may receive device information (e.g., a serial number, a model name, IMEI, a USIM number, IMSI, and an allocated authentication key) of receiving device 200 and connection state information of receiving device 200. In addition to the message authentication request message, receiver 320 may receive a digital notary request message from receiving device 200. Furthermore, through such an established link, transmitter 310 may transmit an authentication result message, a notary result message, and advertisement messages to receiving device 200.

Memory 330 is data storage storing information necessary for driving messaging server 300 and performing certain operation upon generation of a predetermined event. Such information may include any software programs and related data. Memory 340 may be a flash memory, hard disk, multimedia card micro memory, SD or XD memory, Random Access Memory (RAM), Static Random Access Memory (SRAM), Read-Only Memory (ROM), Programmable Read-Only Memory (PROM), Electrically Erasable Programmable Read-Only Memory (EEPROM), magnetic memory, magnetic disk, or optical disk, but is not limited thereto.

Processor 340 may be a central processing unit (CPU) that controls overall operation of the constituent elements of messaging server 300. In accordance with at least one embodiment, processor 340 may perform a message authentication procedure based on information included in the message authentication request message in cooperation with message database 400 and perform operations for obtaining advertisement information associated with a sender of the message based on the transmitting number in the message authentication request message in cooperation with advertisement contents database 600. Processor 340 may perform operations for generating an advertisement message to include the obtained advertisement information and transmit the generated advertisement message with the message authentication result message to receiving device 200.

Upon the receipt of device information of receiving device 200, messaging server 300 may perform operation for authenticating receiving device 200 in order to prevent an unauthorized person (e.g., hacker) from illegally notarizing an associated message although such an unauthorized person illegally obtains authentication information of receiving device 200. Furthermore, based on the connection state information of receiving device 200, messaging server 300 may perform operations for determining whether receiving device 200 is capable of a large amount of advertisement data.

Processor 340 may perform operations for determining whether a transmitting number of a target message is a spam number based on a spam number list stored in a database. As a result of determination, processor 340 may perform operations for generating and transmitting a spam number warning message.

For requesting a digital notary service to notary service server 600, processor 340 may perform operations for transmitting information on a target message and receiving device 200, such as a transmitting number of transmitting device 100 (e.g., a sender), a receiving number of receiving device 200, a transmission time of a target message, contents of the target message, information on whether the target message is read by a receiver, a predetermined hash value, and so forth.

Hereinafter, such operation of messaging server 300 will be described in detail with reference to FIG. 4. FIG. 4 illustrates a method for authenticating a message by a messaging server in accordance with another embodiment.

Referring to FIG. 4, a message from a transmitting device may be delivered to a receiving device and the delivered message and associated information may be stored at step S4010. For example, messaging server 300 may receive a message transmission request with a message from transmitting device 100. Upon the receipt of the message transmission request and the message to transmit, messaging server 300 may determine a destination (e.g., receiving device 200) based on information included in the message transmission request and the message and deliver the message to the determined destination.

Messaging server 300 may extract authentication information from the message transmission request and the message and store the extracted authentication information in message server 400 in accordance with at least one embodiment. The extracted authentication information may include information on an origin, a destination, a time stamp (e.g., transmission time), and contents of the message.

At step S4020, an authentication request message may be received. For example, messaging server 300 receives an authentication request message from receiving device 200 through communication network 800.

At step S4030, a message authentication procedure may be performed based on the extracted information. For example, messaging server 300 may extract information from the received authentication request message and perform the authentication procedure. In particular, messaging server 300 may find authentication information associated with the received message and stored in message database 400 based on the extracted information, such as a transmitting number, a receiving number, a time stamp, and contents of the received message. The authentication information associated with the received message may be information of the received message stored when the message is transmitted from transmitting device 200.

Messaging server 300 may compare the extracted information of the received message with the stored authentication information of the received message in accordance with at least one embodiment. Messaging server 300 may determine whether the received message is good or bad according to the comparison result.

Based on the extracted information, messaging server 300 may further determine whether a transmitting number of the received message is in a spam list, determine whether contents include virus, or determine whether a suspicious file is attached at the received message.

At step S4040, messaging server 300 may determine the target message is bad or good based on the comparison results. That is, when the stored authentication information is different from the extracted information, when the transmitting number is in the spam list, when the contents include virus, or when the suspicious file is attached, messaging server 300 determines that the authentication fails and determines the received message is a bad message. On the contrary, when the stored authentication information is identical to the extracted information, when the transmitting number is not in the spam list, when the contents do not include virus, or when the suspicious file is not attached, messaging server 300 determines that the authentication successes and determines the received message is a good message.

When the target message is bad (Bad—S4040), messaging server 300 may add a transmitting number of the target message to a SPAN list database at step S4050, generate a bad authentication result message at step S4060, and transmit the generated bad authentication result message at step S4070. The bad authentication result message may initiate receiving device 200 to display at least one of authentication result window 840 of FIG. 8, authentication result window 920 of FIG. 9, and authentication result window 940 of FIG. 10. When the target message is good (Good—S4040), messaging server 300 may generate a good authentication result message at step S4080. Such a good authentication result message may initiate receiving device 200 to display authentication result window 520 of FIG. 7.

At step S4090, messaging server 300 may determine whether a digital notary service is requested based on information received from receiving device 200. When a recipient activates the notary service as shown in FIG. 5, receiving device 200 may transmit a notary request with the authentication request message.

When the notary service is requested (Yes—S4090), messaging server 300 may request notary service server 600 and receive a notary service result from notary service server 600 at step S4100. At step S4110, messaging server 300 may generate and transmit a notary service result message to the receiving device. For example, notary service server 600 may notarize a target message in response to a request from messaging server 300 in cooperation with public notary agency 700. Notary service server 600 may receive a notary service request message from messaging server 300 with information on a target message to be notarized, request the notary service to public notary agency 700 by delivering the information on the target message to public notary agency 700, and receive a notarizing result from public notary agency 700. Public notary agency 700 may i) receive a notary request message from notary service server 600 with information on a target message, store information on the received target message for a predetermined time period; ii) inquire at least one information on the target message to a message sender (e.g., transmitting device 100), to a message recipient (e.g., receiving device 200), to messaging server 300, in order to determine whether a message sender transmits a target message, determine whether a message recipient receives a target message, determine whether contents of a target message is not modified, and so forth; iii) transmit the inquiry result of a target message to at least of notary service server 600, messaging server 300, receiving device 200, and transmitting device 100.

At step S4120, messaging server 300 determines whether the receiving device is connected to a data network based on the connection state information. When the receiving device is not connected based on the connection state information (No—S4120), messaging server 300 may generate a short advertisement message at step S4130 and transmit the authentication result message, the notary service result message, and the short advertisement message to the receiving device at step S4140.

When the receiving device is connected based on the connection state information (Yes—S4120), messaging server 300 may generate a long advertisement message at step S4150 and transmit the authentication result message, the notary service result message, and the long advertisement message to receiving device 200 at step S4160.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of authenticating a digital message by a device, the method comprising:
transmitting an authentication request message to a messaging server when a message is received;
receiving an authentication result from the messaging server; and
displaying the authentication result with the received message.

2. The method of claim 1, wherein the transmitting comprises:
extracting information on a transmitting number, a receiving number, a time stamp, and contents from the received message; and
transmitting the extracted information with the authentication request message.

3. The method of claim 1, wherein the transmitting comprises:
generating the authentication request message to include information on a transmitting number, a receiving number, a time stamp, and contents of the received message and transmitting the generated authentication request message automatically when the message is received.

4. The method of claim 1, wherein transmitting comprises:
inquiring a user of the device whether to request message authentication;
when the user requests the message authentication, extracting information on a transmitting number, a receiving number, a time stamp, and contents from the received message, generating the authentication request message to include the extracted information, and transmitting the generated authentication request message.

5. The method of claim 1, wherein the transmitting comprises transmitting device information of the device to the messaging server.

6. The method of claim 1, wherein the transmitting comprise transmitting connection state information of the device to the messaging server.

7. The method of claim 1, wherein the receiving comprise receiving advertisement information associated with a transmitting number of the received message from the messaging server.

8. The method of claim 1, wherein the receiving comprises:
receiving a long advertisement message associated with a transmitter number of the received message from the messaging server when the device is connected to a data network for receiving data at a comparatively high transmit rate;
otherwise, receiving a short advertisement message associated with the transmitter number of the received message from the messaging server.

9. The method of claim 1, wherein the displaying comprises displaying advertisement information associated with a transmitting number of the received message with the authentication result.

10. The method of claim 1, comprising:
inquiring a user of the device whether to request a digital notary service; and
when the user requests the digital notary service, extracting information on a transmitting number, a receiving number, a time stamp, and contents from the received message, generating a notary request message to include the extracted information, and transmitting the generated notary request message.

11. A method of authenticating a message by a server, the method comprising:
receiving an authentication request message for requesting authentication of a target message from a device that received the target message;
performing an authentication procedure in response to the received authentication request message; and
transmitting an authentication result message to the device.

12. The method of claim 11, wherein the receiving comprises:
extracting information on the target message from the received authentication request message, wherein the extracted information includes information on a transmitting number, a receiving number, a time stamp, and contents of the target message.

13. The method of claim 11, wherein the performing comprises:
comparing target message information extracted from the received authentication request message with associated authentication information stored in a database of the server; and
determining whether the target message information is about identical to the associated authentication information.

14. The method of claim 11, wherein the performing comprises:
determining that the target message is authenticated when target message information is about identical to associated authentication information stored in the server when the target message is transmitted from the other device.

15. The method of claim 11, wherein the performing comprises:
determining whether a transmitting number of the target message is included in a spam list stored in a database of the server.

16. The method of claim 11, further comprising:
obtaining an advertisement message associated with a transmitting number of the target message from an associated database; and
transmitting the obtained advertisement message with the authentication result message to the device.

17. The method of claim 11, further comprising:
receiving connection state information of the device from the device; and
determining whether the device is connected to a data network for receiving data at a comparatively high transmit rate based on the connection state information.

18. The method of claim 17, wherein the transmitting comprises:
transmitting a comparatively short advertisement message with the authentication result message when the device is not connected to the data network; and
transmitting a comparatively long advertisement message with the authentication result message when the device is connected to the data network.

19. The method of claim 11, further comprising:
receiving a notary service request message from the device;
extracting notary information and target message information from the notary service request message and requesting a notary service server to notarize a target message based on the extracted notary information and target message information; and
receiving a notary result message and transmitting the received notary result message to the device.

20. The method of claim 11, further comprising:
receiving a message to be transmitted to a designated device;
extracting information on at least one of a transmitting number, a receiving number, a time stamp, and contents from the message; and
storing the extracted information as authentication information of the received message.
